(19) United States
(12) Patent Application Publication
(10) Pub. No.: US 2025/0108580 A1
(43) Pub. Date: Apr. 3, 2025

(54) GREEN COMPACT FORMING DEVICE

(71) Applicant: Panasonic Intellectual Property Management Co., Ltd., Kadoma-shi, Osaka (JP)

(72) Inventor: Satoru Maeda, Kanagawa (JP)

(73) Assignee: Panasonic Intellectual Property Management Co., Ltd., Kadoma-shi, Osaka (JP)

(21) Appl. No.: 18/730,966

(22) PCT Filed: Oct. 19, 2022
(86) PCT No.: PCT/JP2022/038893

§ 371 Date: Jul. 22, 2024

(30) Foreign Application Priority Data
Jan. 25, 2022 (JP) 2022-009042

(51) Int. Cl. B30B 11/00; B30B 15/14; H01M 4/139

(52) U.S. Cl. CPC B30B 11/006; B30B 15/148; H01M 4/139

(57) ABSTRACT

A green compact forming device includes: a reservoir of powder; a first forming roll and a second forming roll structured to be adjacent to each other at a predetermined interval, the powder fed to a gap between the two rolls, the powder compressed into a sheet shape by rotation of the two rolls to form a green compact, the second forming roll supporting and conveying the green compact on a circumferential surface; a first information acquisitor structured to acquire powder information regarding an amount of the powder stored in the reservoir; and a controller structured to control a circumferential speed of the second forming roll based on the powder information.

### CROSS-REFERENCE TO RELATED APPLICATIONS

This application is based upon and claims the benefit of priority from the prior Japanese Patent Application No. 2022-009042, filed on Jan. 25, 2022, and the International Patent Application No. PCT/JP2022/038893, filed on Oct. 19, 2022, the entire content of each of which is incorporated herein by reference.

### BACKGROUND

### Field of the Invention

The present disclosure relates to a green compact forming device.

### Description of the Related Art

Patent Literature 1 describes a technique of feeding powder (granule) to a gap between a pair of rolls and compressing the powder to obtain a green compact having a sheet shape.

Patent Literature 1: JP 2018-186033

From the viewpoint of improving the performance of a product using the green compact or the like, there is a demand for making the basis weight (also referred to as density) of the green compact more uniform.

### SUMMARY OF THE INVENTION

The present disclosure has been made in view of such a circumstance, and an object thereof is to provide a technique for making the basis weight of the green compact uniform.

An aspect of the present disclosure is a green compact forming device. The device includes: a reservoir of powder; a first forming roll and a second forming roll structured to be adjacent to each other at a predetermined interval, the powder fed from the reservoir to a gap between the two rolls, the powder compressed into a sheet shape by rotation of the two rolls to form a green compact, the second forming roll supporting and conveying the green compact on a circumferential surface; a first information acquisitor structured to acquire powder information regarding an amount of the powder stored in the reservoir; and a controller structured to control a circumferential speed of the second forming roll based on the powder information.

Another aspect of the present disclosure is also a green compact forming device. The device includes: a reservoir of powder; a first forming roll and a second forming roll structured to be adjacent to each other at a predetermined interval, the powder fed from the reservoir to a gap between the two rolls, the powder compressed into a sheet shape by rotation of the two rolls to form a green compact, the second forming roll supporting and conveying the green compact on a circumferential surface; at least one conveying roll structured to be positioned downstream of the second forming roll in a conveyance direction of the green compact, and support and convey the green compact on a circumferential surface; a second information acquisitor structured to acquire basis weight information regarding a basis weight of the green compact, the second information acquisitor acquiring the basis weight information of the green compact on a circumferential surface of two or more rolls of the second forming roll and the conveying roll; and a controller structured to control a circumferential speed of the second forming roll based on the basis weight information.

Any combinations of the above components and modifications of the expressions of the present disclosure between a method, a device, a system, and the like are also effective as aspects of the present disclosure.

### BRIEF DESCRIPTION OF DRAWINGS

Embodiments will now be described, by way of example only, with reference to the accompanying drawings which are meant to be exemplary, not limiting, and wherein like elements are numbered alike in several Figures, in which:

FIG. 1 is a schematic diagram of a green compact forming device according to a first embodiment;

FIG. 2 is a schematic diagram of a green compact forming device according to a first modification;

FIG. 3 is a schematic diagram of a green compact forming device according to a second embodiment; and

FIG. 4 is a schematic diagram of a green compact forming device according to a second modification.

### DETAILED DESCRIPTION OF THE INVENTION

Hereinafter, the present disclosure will be described on the basis of preferred embodiments with reference to the drawings. The embodiments are not intended to limit the present disclosure but examples, and all features described in the embodiments and combinations thereof are not necessarily essential to the present disclosure. The same or equivalent components, members, and processing illustrated in the drawings are denoted by the same reference numerals, and redundant description is omitted as appropriate.

In addition, the scale and shape of each portion illustrated in each drawing are set for convenience in order to facilitate the description, and are not limitedly interpreted unless otherwise specified. In addition, when the terms “first”, “second”, and the like are used in the present specification or claims, unless otherwise specified, these terms do not represent any order or importance, and are intended to distinguish one configuration from another configuration. In addition, in each drawing, some of the members that are not important for describing the embodiments are omitted.

### First Embodiment

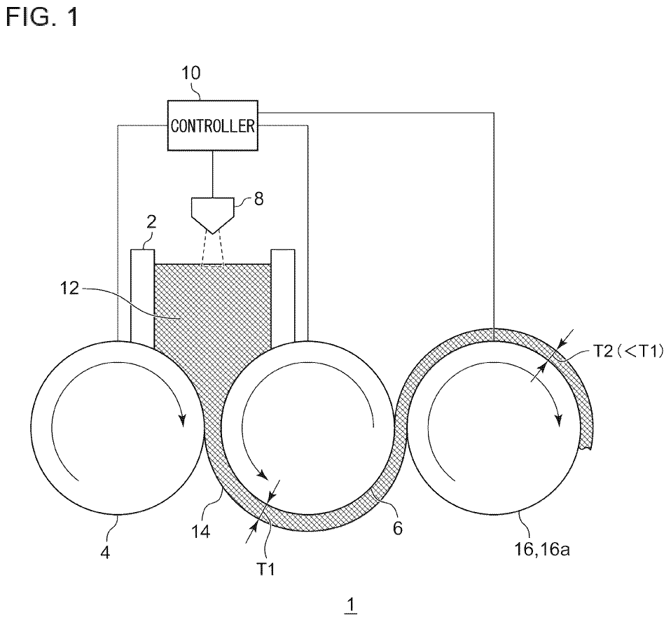

FIG. 1 is a schematic diagram of a green compact forming device 1 according to a first embodiment. In FIG. 1, some of the components of the green compact forming device 1 are depicted as a functional block. This functional block is achieved by an element or a circuit such as a CPU or a memory of a computer as a hardware configuration, and is achieved by a computer program or the like as a software configuration.

It is understood by those skilled in the art that these functional blocks can be achieved in various forms by a combination of hardware and software.

The green compact forming device 1 includes a reservoir 2, a first forming roll 4, a second forming roll 6, a first information acquisitor 8, and a controller 10. The reservoir 2 has a known structure such as a combination of a hopper and a feeder, and stores powder 12 as a source material of a green compact 14. Then, the powder 12 is fed to the first forming roll 4 and the second forming roll 6.

The powder 12 contains predetermined particles and a binding component that binds the particles to each other. The binding component includes at least one of a known binding agent (binder) or a solvent. In addition, in the powder 12 as an example, the content of the binding component is 20 mass % or less, 10 mass % or less, or 1 mass % or less with respect to the total mass of the powder 12. For example, the total content of the binding agent and the solvent is 20 mass % or less, 10 mass % or less, or 1 mass % or less with respect to the total mass of the powder 12. That is, the powder 12 as an example is dry powder.

The first forming roll 4 and the second forming roll 6 are disposed at a powder outlet of the reservoir 2. The orientations of the first forming roll 4 and the second forming roll 6 are set so that their rotation axes are parallel to each other, and the first forming roll 4 and the second forming roll 6 are adjacent to each other at a predetermined interval. The second forming roll 6 is disposed downstream of the first forming roll 4 in a conveyance direction of the green compact 14. The powder 12 is fed from the reservoir 2 to the gap between the first forming roll 4 and the second forming roll 6. The first forming roll 4 and the second forming roll 6 of the present embodiment also function as feed rolls of a feeder, and feed the powder 12 in the reservoir 2 to the gap between the two forming rolls by placing the powder 12 on the roll circumferential surfaces.

The first forming roll 4 and the second forming roll 6 rotate in opposite directions, and compress the powder 12 fed to the gap into a sheet shape. As a result, the green compact 14 is formed. The green compact 14 is continuously sent from the gap between the first forming roll 4 and the second forming roll 6. Accordingly, the green compact 14 has a belt shape elongated in the conveyance direction. The green compact 14 is conveyed downstream while being supported on the circumferential surface of the second forming roll 6.

The green compact forming device 1 of the present embodiment includes at least one conveying roll 16 on the downstream side of the second forming roll 6 in the conveyance direction of the green compact 14. The conveying roll 16 supports and conveys the green compact 14 on the circumferential surface. In addition, the conveying roll 16 includes a stretching and conveying roll 16a that conveys the green compact 14 and stretches the green compact 14 to a target thickness. In the present embodiment, the stretching and conveying roll 16a is adjacent to the second forming roll 6.

The orientation of the stretching and conveying roll 16a is set so that the rotation axis is parallel to the rotation axis of the second forming roll 6, and the stretching and conveying roll 16a is adjacent to the second forming roll 6 at a predetermined interval. The green compact 14 passes through a gap between the second forming roll 6 and the stretching and conveying roll 16a. The second forming roll 6 and the stretching and conveying roll 16a can convey the green compact 14 by rotating in opposite directions with the green compact 14 interposed therebetween. In addition, the second forming roll 6 and the stretching and conveying roll 16a rotate at circumferential speeds different from each other. Specifically, the rotation speed of the stretching and conveying roll 16a is faster than the rotation speed of the second forming roll 6. As a result, the green compact 14 can be conveyed, and the green compact 14 can be stretched by a circumferential speed difference therebetween. Accordingly, thickness T2 of the green compact 14 positioned on the circumferential surface of the stretching and conveying roll 16a becomes smaller than thickness T1 of the green compact 14 positioned on the circumferential surface of the second forming roll 6. Note that, in this configuration, it can be interpreted that the second forming roll 6 also functions as a stretching and conveying roll.

The green compact 14 is conveyed while being supported on the circumferential surface of the second forming roll 6, and is delivered to the stretching and conveying roll 16a side at a position where the second forming roll 6 and the stretching and conveying roll 16a face each other. Then, it is supported on the circumferential surface of the stretching and conveying roll 16a and conveyed to the downstream side. The green compact 14 being conveyed is always kept in contact with the circumferential surface of the second forming roll 6 and the circumferential surface of the stretching and conveying roll 16a. Note that one or more conveying rolls 16 (including stretching and conveying roll 16a) may be further arranged on the downstream side of the stretching and conveying roll 16a adjacent to the second forming roll 6. In addition, one or more conveying rolls 16 (including stretching and conveying roll 16a) may be interposed between the second forming roll 6 and the stretching and conveying roll 16a.

The green compact forming device 1 of the present embodiment is designed so that the green compact 14 has a final thickness, in other words, a target thickness, on the circumferential surface of the stretching and conveying roll 16a adjacent to the second forming roll 6. For example, the thickness T1 is 100 to 2000 μm, and the thickness T2 (target thickness) is 50 to 200 μm. Preferably, the target thickness is 200 times or less the particle diameter of the powder 12. Note that, it is not limited to this configuration, and the green compact 14 may be designed to have a target thickness on the stretching and conveying roll 16a downstream of the stretching and conveying roll 16a adjacent to the second forming roll 6.

The first information acquisitor 8 acquires powder information regarding the amount of the powder 12 stored in the reservoir 2. The first information acquisitor 8 as an example includes a known level sensor, and acquires the height of the bulk of the powder 12 accumulated in the reservoir 2 as the powder information. The level sensor may be of any type such as a laser type, an ultrasonic type, or a capacitance type. In addition, the first information acquisitor 8 may include a known mass meter and acquire the mass of the powder 12 in the reservoir 2 as the powder information. The first information acquisitor 8 sends the acquired powder information to the controller 10.

The controller 10 controls the circumferential speed (rotation speed) of the second forming roll 6 based on the powder information received from the first information acquisitor 8. For example, the controller 10 controls the output of a motor that rotates the second forming roll 6. The controller 10 can be configured by a digital processor, may be configured by, for example, a combination of a microcomputer including a CPU and a software program, or may be configured by a field programmable gate array (FPGA), an application specified IC (ASIC), or the like.

When the amount of the powder 12 stored in the reservoir 2 is large, the amount of the powder 12 discharged from the reservoir 2 and fed to the first forming roll 4 and second forming roll 6 side tends to increase due to the weight of the accumulated powder 12. In addition, when the circumferential surfaces of the first forming roll 4 and the second forming roll 6 are in contact with the powder 12 in the reservoir 2, the area of the roll circumferential surface in contact with the powder 12 increases as the amount of the stored powder 12 is large. Therefore, the amount of the powder 12 fed from the reservoir 2 to the gap between the two forming rolls tends to increase. On the other hand, when the amount of the powder 12 stored in the reservoir 2 decreases, the entire weight of the accumulated powder 12 decreases, and thus the amount of the powder 12 fed to the gap between the two forming rolls decreases. In addition, when the height of the bulk of the powder 12 is lower than the upper ends of the two forming rolls, the amount of the powder 12 in contact with the roll circumferential surfaces decreases, so that the amount of the powder 12 fed to the gap between the two forming rolls decreases.

In addition, when the circumferential speed of the second forming roll 6 decreases, the discharge rate (discharge amount per unit time) of the powder 12 from the reservoir 2 decreases. Accordingly, the amount of the powder 12 fed to the gap between the first forming roll 4 and the second forming roll 6 tends to decrease. On the other hand, when the circumferential speed of the second forming roll 6 increases, the discharge rate of the powder 12 increases. Accordingly, the amount of the powder 12 fed to the gap between the two forming rolls tends to increase.

When the amount of the powder 12 fed to the gap between the first forming roll 4 and the second forming roll 6 is large, the basis weight (or density) of the green compact 14 increases. On the other hand, when the amount of the powder 12 fed to the gap is small, the basis weight of the green compact 14 decreases. Further, the formed green compact 14 is conveyed while being supported on the circumferential surface of the second forming roll 6. Accordingly, the circumferential speed of the second forming roll 6 has a greater effect on the sending out of the green compact 14 than the circumferential speed of the first forming roll 4. Then, the sending-out timing of the green compact 14 affects the basis weight of the green compact 14. Accordingly, the effect of the second forming roll 6 on the basis weight of the green compact 14 is greater than the effect of the first forming roll 4 on the basis weight of the green compact 14.

Thus, the controller 10 increases the circumferential speed of the second forming roll 6 when the amount of the powder 12 stored in the reservoir 2 decreases. That is, when the powder 12 has a first amount, the controller 10 adjusts the circumferential speed of the second forming roll 6 to a first speed. In addition, when the powder 12 has a second amount smaller than the first amount, the circumferential speed of the second forming roll 6 is adjusted to a second speed faster than the first speed. The second forming roll 6 is rotated relatively slowly when the amount of the powder 12 in the reservoir 2 is relatively large, and the second forming roll 6 is rotated relatively faster when the amount of the powder 12 in the reservoir 2 is relatively small, so that the basis weight of the green compact 14 can be made uniform. In addition, by making the basis weight of the green compact 14 uniform, the thickness of the green compact 14 can be made more uniform when the green compact 14 is stretched or compressed. The controller 10 switches the circumferential speed of the second forming roll 6 in at least two stages. More preferably, the controller 10 switches the circumferential speed of the second forming roll 6 in multiple stages of three or more stages or continuously (steplessly).

As an example, the controller 10 controls the circumferential speed of the second forming roll 6 based on Formula (1) described below.

$${V}_{1} = {V}_{0} \times A \qquad Formula ( 1 )$$

That is, the controller 10 calculates the circumferential speed V₁ by multiplying the circumferential speed V₀ of the second forming roll 6 when the powder information is acquired by the coefficient A corresponding to the powder amount. Then, the circumferential speed of the second forming roll 6 is changed from V₀ to V₁.

The coefficient A is, for example, a value obtained by multiplying the measured powder amount δ by an arbitrary powder amount coefficient D (A=δD). The powder amount coefficient D is set according to, for example, the bulk density and the compressibility of the powder 12. For example, the powder amount coefficient D increases as the compressibility of the powder 12 increases. Note that the controller 10 may hold in advance a conversion table associating the powder information with the circumferential speed of the second forming roll 6, and determine the circumferential speed of the second forming roll 6 from the powder information based on the conversion table. In addition, the controller 10 may hold a reference value H related to the height of the bulk of the powder 12 in the reservoir 2, and control the circumferential speed of the second forming roll 6 based on whether the measurement value of the bulk is higher or lower than the reference value H.

In addition, the controller 10 of the present embodiment controls the circumferential speed of the first forming roll 4 together with the circumferential speed of the second forming roll 6. As an example, the controller 10 controls the circumferential speed of the first forming roll 4 so as to be equal to the circumferential speed of the second forming roll 6. By controlling the circumferential speed of the first forming roll 4 in addition to the circumferential speed of the second forming roll 6, it is possible to more easily make the basis weight of the green compact 14 uniform. In addition, it is possible to suppress a decrease in the forming accuracy of the green compact 14 due to an excessive difference in circumferential speed between the first forming roll 4 and the second forming roll 6.

In addition, the controller 10 of the present embodiment controls the circumferential speed of the conveying roll 16 together with the circumferential speed of the second forming roll 6. As an example, the controller 10 changes the circumferential speed of the conveying roll 16 by the same change amount as the change amount of the circumferential speed of the second forming roll 6. As a result, even when the circumferential speed of the second forming roll 6 is changed, it is possible to suppress the delay in the conveyance and stretching of the green compact 14.

The use purpose of the green compact 14 is not particularly limited. As an example, the green compact 14 is an electrode mixture layer used for a lithium ion secondary battery or the like. In this case, the powder 12 contains an electrode active material as predetermined particles, and the green compact 14 is stacked on a current collector plate. In addition, the green compact 14 may be a hydrogen storage sheet or the like used for a fuel cell or the like.

As described above, the green compact forming device 1 according to the present embodiment includes the reservoir 2 of the powder 12, the first forming roll 4 and the second forming roll 6 adjacent to each other, the first information acquisitor 8, and the controller 10. The first forming roll 4 and the second forming roll 6, when the powder 12 is fed to the gap therebetween, compress the powder 12 by rotation to form the green compact 14 having a sheet shape. In addition, the second forming roll 6 supports and conveys the green compact 14 on the circumferential surface. The first information acquisitor 8 acquires the powder information regarding the amount of the powder 12 in the reservoir 2. The controller 10 controls the circumferential speed of the second forming roll 6 based on the powder information. As a result, even when the stability of the feed amount of the powder 12 is low, the basis weight of the green compact 14 can be made uniform.

In particular, when the powder 12 is dry powder in which the content of the binding component is 20 mass % or less, the fluidity tends to be unstable as compared with that of wet powder or liquid. For this reason, the green compact forming device 1 of the present embodiment can exert the function particularly effectively when the powder 12 is dry powder. Note that the powder 12 may be wet powder in which the content of the binding component is more than 20 mass %.

In addition, the controller 10 of the present embodiment controls the circumferential speed of the first forming roll 4 together with the circumferential speed of the second forming roll 6. As a result, the basis weight of the green compact 14 can be made more uniform. In addition, it is possible to suppress a decrease in forming accuracy of the green compact 14. In addition, the green compact forming device 1 of the present embodiment includes at least one conveying roll 16 positioned on the downstream side of the second forming roll 6. Then, the controller 10 controls the circumferential speed of the conveying roll 16 together with the circumferential speed of the second forming roll 6. As a result, it is possible to suppress the blockage of the conveyance or the like of the green compact 14 by a change in the circumferential speed of the second forming roll 6.

### First Modification

The green compact forming device 1 according to the first embodiment may include a first modification described below. A green compact forming device 1 according to the first modification has a configuration common to the first embodiment except that a controller 10 controls the circumferential speed of a second forming roll 6 in consideration of not only powder information but also basis weight information of a green compact 14. Hereinafter, a configuration of the green compact forming device 1 according to the present modification different from that of the first embodiment will be mainly described, and common configurations will be briefly described or description thereof will be omitted.

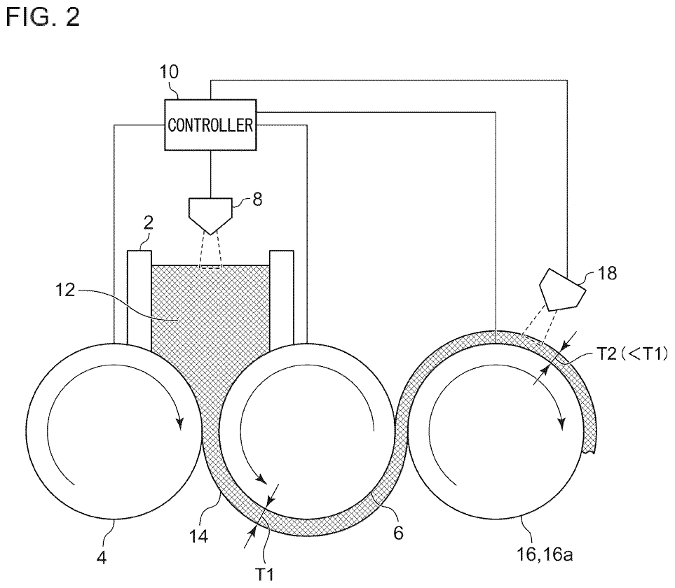

FIG. 2 is a schematic diagram of the green compact forming device 1 according to the first modification. In FIG. 2, similarly to FIG. 1, some of the components of the green compact forming device 1 are depicted as a functional block. The green compact forming device 1 according to the present modification includes a second information acquisitor 18 that acquires basis weight information regarding the basis weight of the green compact 14. Preferably, the second information acquisitor 18 includes a terahertz sensor capable of measuring at least one of the basis weight or the thickness of the green compact 14, and measures the basis weight itself of the green compact 14 or the thickness having a positive correlation with the basis weight as the basis weight information.

The second information acquisitor 18 acquires the basis weight information of the green compact 14 on the circumferential surface of one of the rolls of the second forming roll 6 and a conveying roll 16. The second information acquisitor 18 of the present modification acquires the basis weight information of the green compact 14 on the circumferential surface of a stretching and conveying roll 16a that stretches the green compact 14 to a target thickness. In the present modification, the conveying roll 16 adjacent to the second forming roll 6 is the stretching and conveying roll 16a that stretches the green compact 14 to a target thickness. Note that the position where the second information acquisitor 18 acquires the basis weight information may be on the circumferential surface of another conveying roll 16 or on the circumferential surface of the second forming roll 6.

The controller 10 controls the circumferential speed of the second forming roll 6 based on the powder information and the basis weight information. First, the correspondence relationship between the basis weight information and the control of the circumferential speed of the second forming roll 6 is as described below. That is, when the acquired basis weight or thickness is larger than a design value, the circumferential speed of the second forming roll 6 is relatively reduced. As a result, the discharge rate of the powder 12 from the reservoir 2 can be reduced, and the basis weight of the green compact 14 can be reduced. On the other hand, when the acquired basis weight or thickness is smaller than the design value, the circumferential speed of the second forming roll 6 is relatively increased. As a result, the discharge rate of the powder 12 from the reservoir 2 can be increased, and the basis weight of the green compact 14 can be increased. When the basis weight information is acquired on the circumferential surface of the stretching and conveying roll 16a that stretches the green compact 14 to a target thickness, the design value is equal to a target value. When the basis weight information is acquired on the circumferential surface of the second forming roll 6 or on the circumferential surface of another conveying roll 16 (including another stretching and conveying roll 16a), the design value is set based on the target value and the amount stretched after the acquisition position.

When the circumferential speed of the second forming roll 6 is controlled based on the powder information and the basis weight information, as an example, the controller 10 calculates the coefficient A based on Formula (2) described below.

$$A = a ( 1 - {X}_{1} ) + δ {DX}_{1} \qquad Formula ( 2 )$$

a(1−X₁) in Formula (2) is a component related to the basis weight information, and is a value obtained by multiplying deviation a (a=actual measurement value/design value) between the design value and the actual measurement value by weighting coefficient 1−X₁. δDX₁ is a component related to the powder information, and is a value obtained by multiplying the measured powder amount δ by the powder amount coefficient D and the weighting coefficient X₁ described above.

X₁ is a value satisfying 0<X₁<1. More preferably, when the basis weight information is acquired on the circumferential surface of the stretching and conveying roll 16a that stretches the green compact 14 to a target thickness, X₁ is a value satisfying 0<X₁<0.5. That is, the circumferential speed of the second forming roll 6 is set with emphasis on the basis weight information rather than the powder information. On the other hand, when the basis weight information is acquired on the circumferential surface of the second forming roll 6, X₁ is a value satisfying 0.5<X₁<1. That is, the circumferential speed of the second forming roll 6 is set with emphasis on the powder information rather than the basis weight information.

Then, the controller 10 calculates the circumferential speed V₁ on the basis of Formula (1), and changes the circumferential speed of the second forming roll 6 from V₀ to V₁. As described above, by controlling the circumferential speed of the second forming roll 6 based on the basis weight information in addition to the powder information, it is possible to more easily make the basis weight of the green compact 14 uniform. In addition, by acquiring the basis weight information of the green compact 14 on the circumferential surface of the stretching and conveying roll 16a that stretches the green compact 14 to the target thickness, the basis weight of the green compact 14 can be made uniform with higher accuracy.

### Second Embodiment

A green compact forming device 1 according to the second embodiment has a configuration common to the first embodiment except that a controller 10 controls the circumferential speed of a second forming roll 6 based on the basis weight information acquired on a plurality of roll circumferential surfaces instead of the powder information. Hereinafter, a configuration of the green compact forming device 1 according to the present embodiment different from that of the first embodiment will be mainly described, and common configurations will be briefly described or description thereof will be omitted.

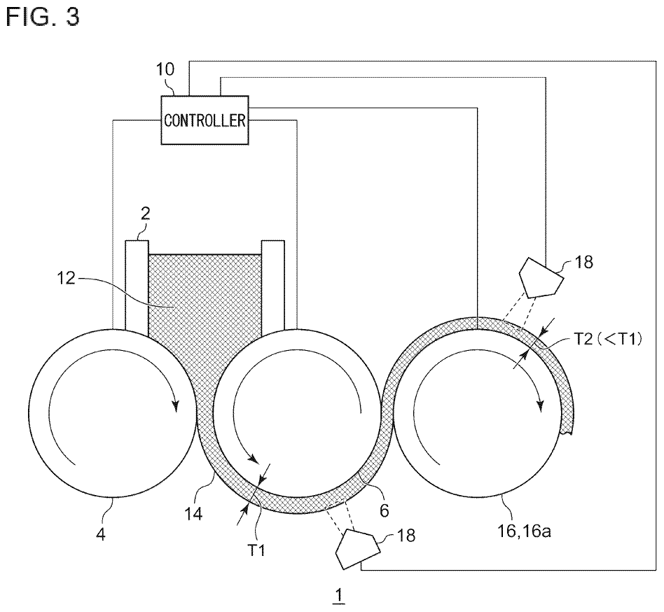

FIG. 3 is a schematic diagram of the green compact forming device 1 according to the second embodiment. In FIG. 3, similarly to FIG. 1, some of the components of the green compact forming device 1 are depicted as a functional block. The green compact forming device 1 according to the present embodiment includes a second information acquisitor 18 that acquires basis weight information of a green compact 14. Preferably, the second information acquisitor 18 includes a terahertz sensor, and measures the basis weight itself or the thickness of the green compact 14 as the basis weight information.

The second information acquisitor 18 acquires the basis weight information of the green compact 14 on the circumferential surface of two or more rolls of the second forming roll 6 and a conveying roll 16. The second information acquisitor 18 of the present embodiment acquires the basis weight information of the green compact 14 on the circumferential surface of the second forming roll 6 and the basis weight information of the green compact 14 on the circumferential surface of a stretching and conveying roll 16a that stretches the green compact 14 to a target thickness. In the present embodiment, the conveying roll 16 adjacent to the second forming roll 6 is the stretching and conveying roll 16a that stretches the green compact 14 to a target thickness. Note that the position where the second information acquisitor 18 acquires the basis weight information may be on the circumferential surface of the second forming roll 6 and the circumferential surface of another conveying roll 16, or may be on the circumferential surfaces of two other conveying rolls 16. In addition, the second information acquisitor 18 may acquire the basis weight information on three or more roll circumferential surfaces.

The controller 10 controls the circumferential speed of the second forming roll 6 based on the basis weight information acquired on the plurality of roll circumferential surfaces. When the circumferential speed of the second forming roll 6 is controlled based on the two pieces of basis weight information, as an example, the controller 10 calculates the coefficient A based on Formula (3) described below.

$$A = a ( 1 - {X}_{2} ) + b {X}_{2} \qquad Formula ( 3 )$$

a(1−X₂) in Formula (3) is a component related to the basis weight information acquired on the circumferential surface of the stretching and conveying roll 16a, and is a value obtained by multiplying deviation a between the design value and the actual measurement value by weighting coefficient 1−X₂. bX₂ is a component related to the basis weight information acquired on the circumferential surface of the second forming roll 6, and is a value obtained by multiplying deviation b between the design value and the actual measurement value by weighting coefficient X₂.

X₂ is a value satisfying 0<X₂<1. More preferably, X₂ is a value satisfying 0<X₂<0.5. That is, the circumferential speed of the second forming roll 6 is set with emphasis on the basis weight information acquired on the circumferential surface of the stretching and conveying roll 16a that stretches the green compact 14 to the target thickness.

Then, the controller 10 calculates the circumferential speed V₁ on the basis of Formula (1), and changes the circumferential speed of the second forming roll 6 from V₀ to V₁. As described above, by controlling the circumferential speed of the second forming roll 6 based on the basis weight information acquired from the plurality of roll circumferential surfaces, it is possible to more easily make the basis weight of the green compact 14 uniform. In addition, by acquiring the basis weight information of the green compact 14 on the circumferential surface of the second forming roll 6 and the basis weight information of the green compact 14 on the circumferential surface of the stretching and conveying roll 16a that stretches the green compact 14 to the target thickness, the basis weight of the green compact 14 can be made uniform with higher accuracy.

### Second Modification

The green compact forming device 1 according to the second embodiment may include a second modification described below. A green compact forming device 1 according to the second modification has a configuration common to the second embodiment except that a controller 10 controls the circumferential speed of a second forming roll 6 in consideration of not only basis weight information acquired on a plurality of roll circumferential surfaces but also powder information. Accordingly, the second modification can also be interpreted as a combination of the first embodiment and the second embodiment. In addition, it can also be interpreted as a configuration in which a plurality of information acquisition positions of the second information acquisitor 18 is provided in the first modification. Hereinafter, a configuration of the green compact forming device 1 according to the present modification different from each embodiment and the first modification will be mainly described, and common configurations will be briefly described or description thereof will be omitted.

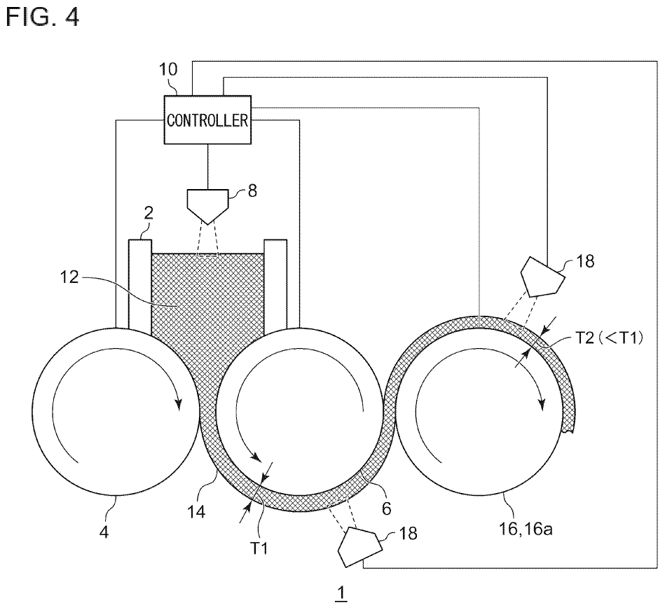

FIG. 4 is a schematic diagram of the green compact forming device 1 according to the second modification. In FIG. 4, similarly to FIG. 1, some of the components of the green compact forming device 1 are depicted as a functional block. The second information acquisitor 18 of the present modification acquires the basis weight information of a green compact 14 on the circumferential surface of the second forming roll 6 and the basis weight information of the green compact 14 on the circumferential surface of a stretching and conveying roll 16a that stretches the green compact 14 to a target thickness. In the present modification, the conveying roll 16 adjacent to the second forming roll 6 is the stretching and conveying roll 16a that stretches the green compact 14 to a target thickness.

The controller 10 controls the circumferential speed of the second forming roll 6 based on the powder information and the basis weight information acquired from the plurality of roll circumferential surfaces. In this case, as an example, the controller 10 calculates the coefficient A on the basis of Formula (4) described below.

$$A = a ( 1 - {X}_{1} - {X}_{2} ) + {bX}_{2} + δ {DX}_{1} \qquad Formula ( 4 )$$

a(1−X₁−X₂) in Formula (4) is a component related to the basis weight information acquired on the circumferential surface of the stretching and conveying roll 16a, and is a value obtained by multiplying deviation a between the design value and the actual measurement value by weighting coefficient 1−X₁−X₂. bX₂ is a component related to the basis weight information acquired on the circumferential surface of the second forming roll 6, and is a value obtained by multiplying deviation b between the design value and the actual measurement value by weighting coefficient X₂. δDX₁ is a component related to the powder information, and is a value obtained by multiplying the measured powder amount δ by the powder amount coefficient D and the weighting coefficient X₁ described above.

X₁ and X₂ are values satisfying 0<X₁<1, 0<X₂<1, and 0<X₁+X₂<1. More preferably, X₁ and X₂ are values satisfying 0<X₁+X_{2 <}0.5, and X₁>X₂. That is, the circumferential speed of the second forming roll 6 is set with the largest emphasis on the basis weight information acquired on the circumferential surface of the stretching and conveying roll 16a that stretches the green compact 14 to the target thickness and with the second largest emphasis on the powder information.

Then, the controller 10 calculates the circumferential speed V₁ on the basis of Formula (1), and changes the circumferential speed of the second forming roll 6 from V₀ to V₁. As described above, by controlling the circumferential speed of the second forming roll 6 based on the powder information and the basis weight information acquired from the plurality of roll circumferential surfaces, it is possible to more easily make the basis weight of the green compact 14 uniform.

The embodiments of the present disclosure have been described above in detail. The above-described embodiments are merely specific examples for carrying out the present disclosure. The contents of the embodiments do not limit the technical scope of the present disclosure, and many design changes such as change, addition, and deletion of the components can be made without departing from the spirit of the present disclosure defined in the claims. A new embodiment to which a design change is made has the effects of each of the combined embodiment and modification. In the above-described embodiments, the contents for which such a design change can be made are emphasized with notations such as “of the present embodiment” and “in the present embodiment”, but the design change is even in contents without such notations. Any combination of the components included in each embodiment is also effective as an aspect of the present disclosure. The hatching applied to the cross sections in the drawings does not limit the material of the hatched target.

The embodiments may be specified by the items described below.

### First Item

A green compact forming device (1) including:
a reservoir (2) of powder (12);
a first forming roll (4) and a second forming roll (6) structured to be adjacent to each other at a predetermined interval, the powder (12) fed from the reservoir (2) to a gap between the two rolls, the powder (12) compressed into a sheet shape by rotation of the two rolls to form a green compact (14), the second forming roll (6) supporting and conveying the green compact (14) on a circumferential surface;
a first information acquisitor (8) structured to acquire powder information regarding an amount of the powder (12) stored in the reservoir (2); and
a controller (10) structured to control a circumferential speed of the second forming roll (6) based on the powder information.

### Second Item

The green compact forming device (1) according to the first item, including:
at least one conveying roll (16) structured to be positioned downstream of the second forming roll (6) in a conveyance direction of the green compact (14), and support and convey the green compact (14) on a circumferential surface; and
a second information acquisitor (18) structured to acquire basis weight information regarding a basis weight of the green compact (14), the second information acquisitor (18) acquiring the basis weight information of the green compact (14) on a circumferential surface of at least one roll of the second forming roll (6) and the conveying roll (16),
in which
the controller (10) controls a circumferential speed of the second forming roll (6) based on the powder information and the basis weight information.

### Third Item

A green compact forming device (1) including:
a reservoir (2) of powder (12);
a first forming roll (4) and a second forming roll (6) structured to be adjacent to each other at a predetermined interval, the powder (12) fed from the reservoir (2) to a gap between the two rolls, the powder (12) compressed into a sheet shape by rotation of the two rolls to form a green compact (14), the second forming roll (6) supporting and conveying the green compact (14) on a circumferential surface;
at least one conveying roll (16) structured to be positioned downstream of the second forming roll (6) in a conveyance direction of the green compact (14), and support and convey the green compact (14) on a circumferential surface;
a second information acquisitor (18) structured to acquire basis weight information regarding a basis weight of the green compact (14), the second information acquisitor (18) acquiring the basis weight information of the green compact (14) on a circumferential surface of two or more rolls of the second forming roll (6) and the conveying roll (16); and
a controller (10) structured to control a circumferential speed of the second forming roll (6) based on the basis weight information.

### Fourth Item

The green compact forming device (1) according to the second or third item, in which
the conveying roll (16) includes a stretching and conveying roll (16a) structured to convey the green compact (14) and stretch the green compact (14) to a target thickness, and
the second information acquisitor (18) acquires the basis weight information of the green compact (14) on a circumferential surface of the stretching and conveying roll (16a).

### Fifth Item

The green compact forming device (1) according to the fourth item, in which the second information acquisitor (18) acquires the basis weight information of the green compact (14) on the circumferential surface of the second forming roll (6) and the basis weight information of the green compact (14) on the circumferential surface of the stretching and conveying roll (16a).

### Sixth Item

The green compact forming device (1) according to any one of the second to fifth items, in which the controller (10) controls a circumferential speed of the conveying roll (16) together with the circumferential speed of the second forming roll (6).

### Seventh Item

The green compact forming device (1) according to any one of the second to sixth items, in which the second information acquisitor (18) includes a terahertz sensor capable of measuring at least one of the basis weight or a thickness of the green compact (14).

### Eighth Item

The green compact forming device (1) according to any one of the first to seventh items, in which the controller (10) controls a circumferential speed of the first forming roll (4) together with the circumferential speed of the second forming roll (6).

### Ninth Item

The green compact forming device (1) according to any one of the first to eighth items, in which the powder (12) contains predetermined particles and a binding component, and a content of the binding component is 20 mass % or less with respect to a total mass of the powder (12).

### Tenth Item

A green compact forming method including:
feeding powder (12) from a reservoir (2) to a gap between a first forming roll (4) and a second forming roll (6) structured to be adjacent to each other at a predetermined interval;
compressing the powder (12) into a sheet shape by rotation of the first forming roll (4) and the second forming roll (6) to form a green compact (14), and supporting and conveying the green compact (14) on a circumferential surface of the second forming roll (6);
acquiring powder information regarding an amount of the powder (12) stored in the reservoir (2); and
controlling a circumferential speed of the second forming roll (6) based on the powder information.

### Eleventh Item

A green compact forming method including:
feeding powder (12) from a reservoir (2) to a gap between a first forming roll (4) and a second forming roll (6) structured to be adjacent to each other at a predetermined interval;
compressing the powder (12) into a sheet shape by rotation of the first forming roll (4) and the second forming roll (6) to form a green compact (14), and supporting and conveying the green compact (14) on a circumferential surface of the second forming roll (6);
acquiring basis weight information regarding a basis weight of the green compact (14) on a circumferential surface of two or more rolls of the second forming roll (6) and at least one conveying roll (16) structured to be positioned downstream of the second forming roll (6) in a conveyance direction of the green compact (14), and support and convey the green compact (14) on a circumferential surface; and
controlling a circumferential speed of the second forming roll (6) based on the basis weight information.

1. A green compact forming device comprising:
a reservoir of powder;
a first forming roll and a second forming roll structured to be adjacent to each other at a predetermined interval, the powder fed from the reservoir to a gap between the two rolls, the powder compressed into a sheet shape by rotation of the two rolls to form a green compact, the second forming roll supporting and conveying the green compact on a circumferential surface;
a first information acquisitor structured to acquire powder information regarding an amount of the powder stored in the reservoir; and
a controller structured to control a circumferential speed of the second forming roll based on the powder information.

2. The green compact forming device according to claim 1, comprising:
at least one conveying roll structured to be positioned downstream of the second forming roll in a conveyance direction of the green compact, and support and convey the green compact on a circumferential surface; and
a second information acquisitor structured to acquire basis weight information regarding a basis weight of the green compact, the second information acquisitor acquiring the basis weight information of the green compact on a circumferential surface of at least one roll of the second forming roll and the conveying roll,
wherein
the controller controls a circumferential speed of the second forming roll based on the powder information and the basis weight information.

3. A green compact forming device comprising:
a reservoir of powder;
a first forming roll and a second forming roll structured to be adjacent to each other at a predetermined interval, the powder fed from the reservoir to a gap between the two rolls, the powder compressed into a sheet shape by rotation of the two rolls to form a green compact, the second forming roll supporting and conveying the green compact on a circumferential surface;
at least one conveying roll structured to be positioned downstream of the second forming roll in a conveyance direction of the green compact, and support and convey the green compact on a circumferential surface;
a second information acquisitor structured to acquire basis weight information regarding a basis weight of the green compact, the second information acquisitor acquiring the basis weight information of the green compact on a circumferential surface of two or more rolls of the second forming roll and the conveying roll; and
a controller structured to control a circumferential speed of the second forming roll based on the basis weight information.

4. The green compact forming device according to claim 2, wherein
the conveying roll includes a stretching and conveying roll structured to convey the green compact and stretch the green compact to a target thickness, and
the second information acquisitor acquires the basis weight information of the green compact on a circumferential surface of the stretching and conveying roll.

5. The green compact forming device according to claim 4, wherein the second information acquisitor acquires the basis weight information of the green compact on the circumferential surface of the second forming roll and the basis weight information of the green compact on the circumferential surface of the stretching and conveying roll.

6. The green compact forming device according to claim 2, wherein the controller controls a circumferential speed of the conveying roll together with the circumferential speed of the second forming roll.

7. The green compact forming device according to claim 2, wherein the second information acquisitor includes a terahertz sensor capable of measuring at least one of the basis weight or a thickness of the green compact.

8. The green compact forming device according to claim 1, wherein the controller controls a circumferential speed of the first forming roll together with the circumferential speed of the second forming roll.

9. The green compact forming device according to claim 1, wherein the powder contains predetermined particles and a binding component, and a content of the binding component is 20 mass % or less with respect to a total mass of the powder.
